(19) United States
(12) Patent Application Publication
(10) Pub. No.: US 2025/0289064 A1
(43) Pub. Date: Sep. 18, 2025

(54) DUST EXTRACTOR WITH AIRFLOW MONITORING

(71) Applicant: MILWAUKEE ELECTRIC TOOL CORPORATION, Brookfield, WI (US)

(72) Inventors: Julia C. Marsh, Milwaukee, WI (US); Zachary J. Jud, Milwaukee, WI (US); Grayson C. Adams, Brookfield, WI (US); Tyler J. Ott, Brookfield, WI (US); Jacob Longstreet, Brookfield, WI (US); Eric D. Piispanen, Brookfield, WI (US)

(21) Appl. No.: 19/077,992

(22) Filed: Mar. 12, 2025

Related U.S. Application Data
(60) Provisional application No. 63/565,815, filed on Mar. 15, 2024.

(51) Int. Cl. B23B 47/34; B23B 45/00

(52) U.S. Cl. CPC B23B 47/34; B23B 45/003

(57) ABSTRACT

A power tool includes a first housing, a dust box coupled to the first housing and defining an inlet and an outlet, a filter positioned between the inlet and the outlet, and a first motor operating a fan to generate an airflow across the filter between the inlet and the outlet. The power tool also includes a first sensor to sense an airflow characteristic of the airflow and a second sensor to sense an operating parameter of the power tool. A first controller is in communication with the first sensor to monitor the airflow characteristic of the airflow and the second sensor to monitor the operating parameter. The first controller controls operation of the power tool based on a value of the airflow characteristic and the operating parameter.

### CROSS-REFERENCE TO RELATED APPLICATIONS

This application claims the benefit of the U.S. Provisional Patent Application No. 63/565,815, filed Mar. 15, 2024, which is incorporated herein by reference in its entirety.

### BACKGROUND

A power tool (e.g., a chisel hammer, a rotary hammer, an air hammer, a drill, air chisel, etc.) can be used to drill or impact a workpiece with a bit (e.g., to remove material from the workpiece). The power tool, when drilling or impacting the workpiece, may create dust and particulate.

### SUMMARY

According to one aspect of the present disclosure, a power tool can include a first housing. A dust box can be coupled to the first housing and can define an inlet and an outlet. A filter can be positioned between the inlet and the outlet. A first motor can operate a fan to generate an airflow across the filter between the inlet and the outlet. A first sensor can sense an airflow characteristic of the airflow. A second sensor can sense an operating parameter of the power tool. A first controller can be in communication with the first sensor to monitor the airflow characteristic of the airflow and the second sensor to monitor the operating parameter. The controller can control operation of the power tool based on a value of the airflow characteristic and the operating parameter.

In some examples, the operating parameter can be at least one of: a length of a suction tube that extends and retracts relative to the dust box, a fill level of the dust box, and a dust cover being attached to the power tool.

In some examples, the airflow characteristic can be at least one of: an air pressure downstream of the filter, a first concentration of particles in the air around the tool, and a second concentration of particles in the airflow exiting the filter.

In some examples, the first controller can stop the first motor when the value of the airflow characteristic reaches the threshold value.

In some examples, the power tool can further include an alert system in communication with the controller so that the controller can activate the alert system when the value of the airflow characteristic reaches the threshold value.

In some examples, the alert system can include an LED indicator that can be activated by the controller.

In some examples, the power tool can further include a filter cleaning mechanism in communication with the controller so that the controller can activate the filter cleaning mechanism when the value of the airflow characteristic reaches the threshold value.

In some examples, the filter cleaning mechanism can include a solenoid that can be operated by a controller to provide impacts to the filter.

In some examples, the first housing can be a dust extractor housing and the power tool can further include a power tool housing, the dust extractor housing can be configured to removably couple to power tool housing.

In some examples, the first motor can be a dust extractor motor that can be positioned within the dust extractor housing and the power tool can further include a power tool motor configured to perform a work operation of the power tool.

In some examples, the first controller can be positioned within the dust extractor housing to control operation of the dust extractor motor and the power tool can further include a second controller positioned within the power tool housing to control operation of the power tool motor, the first controller can be in communication with the second controller.

In some examples, the second controller can control operation of at least one of the power tool motor and an alert system based on a first signal sent from the first controller when the value of the airflow characteristic reaches the threshold value.

In some examples, the first controller can operate the first motor based on a second signal sent from the second controller to the first controller.

According to another aspect of the present disclosure, a dust extractor for use with a rotary power tool can include a housing. A suction tube can extend from the housing to collect dust and other debris generated by the rotary power tool. A dust box can include an inlet and an outlet, the inlet can be in fluid communication with the suction tube. A suction generator can be configured to generate an airflow to draw the dust through the suction tube and into the dust box, and to draw the airflow through the outlet of the dust box. A filter can be positioned adjacent the outlet of the dust box, the filter can separate the dust from the airflow so that the dust remains within the dust box and clear air flows through the filter. A flow sensing system can include a first pressure sensor that senses a first pressure of clean air exiting the filter and a second pressure sensor that senses a second pressure of dirty air that enters the filter. A controller can be in communication with the pressure sensor, the controller can be configured to calculate a pressure differential between the first pressure and the second pressure and to determine when the dust box is full or when the filter is clogged based on the pressure differential.

In some examples, the controller can turn off the suction generator upon determining that the dust box is full or that the filter is clogged.

In some examples, the dust extractor can further include an alert system in communication with the controller, wherein the controller can activate the alert system upon determining that the dust box is full or that the filter is clogged.

In some examples, the alert system can include a color changing LED.

In some examples, each of the first pressure sensor and the second pressure sensor can sense pressure in corresponding pressure port.

In some examples, the dust extractor can further include a filter cleaning mechanism in communication with the controller, wherein the controller can activate the filter cleaning mechanism upon determining that the dust box is full or that the filter is clogged.

According to yet another aspect of the present disclosure, a dust extractor for use with a rotary power tool can include a housing. A suction tube can extend from the housing, the suction tube can be configured to collect dust and other debris generated by the rotary power tool. A dust box can be in fluid communication with the suction tube. A suction generator can generate an airflow to draw the dust through the suction tube and into the dust box, and through an outlet of the dust box. A flow sensing system can include a pressure port disposed between the suction generator and the dust box, and a pressure sensor positioned outside of the dust box and in fluid communication with the pressure port, wherein the pressure sensor can be configured to detect a pressure differential between the pressure port and atmospheric pressure. A controller can be in communication with the pressure sensor, the controller can be configured to determine when the dust box is full or when a filter is clogged based on the pressure differential.

Other features and aspects of the invention will become apparent by consideration of the following detailed description and accompanying drawings.

### BRIEF DESCRIPTION OF THE DRAWINGS

The accompanying drawings, which are incorporated in and form a part of this specification, illustrate embodiments of the disclosed technology and, together with the description, serve to explain the principles of embodiments of the disclosed technology.

FIG. 1 is an axonometric view of a power tool including a power tool and a dust extractor, according to aspects of the disclosure.

FIG. 2A is another axonometric perspective view of the power tool of FIG. 1.

FIG. 2B is yet another axonometric view of the power tool of FIG. 1.

FIG. 3 is a cross-sectional view of the power tool, taken along section line 3-3 in FIG. 2A.

FIG. 4 is a side view of the dust extractor of FIG. 1.

FIG. 5 is a cross-sectional view of the dust extractor of FIG. 4.

FIG. 6 is a schematic diagram the dust extractor of FIG. 1.

### DETAILED DESCRIPTION

The following discussion is presented to enable a person skilled in the art to make and use embodiments of the disclosed technology. Given the benefit of this disclosure, various modifications to the illustrated embodiments will be readily apparent to those skilled in the art, and the principles herein can be applied to other embodiments and applications without departing from embodiments of the disclosed technology. Thus, embodiments of the disclosed technology are not intended to be limited to embodiments shown but are to be accorded the widest scope consistent with the principles and features disclosed herein.

Dust extractors (e.g., dust collectors) are typically used in tandem with power tools (e.g., hand-held drilling tools, rotary hammers) to collect dust and other debris generated during a drilling operation. Use of a dust extractors may prevent accumulation of dust and other debris at a worksite. Such dust extractors may be attached to a power tool to position a suction inlet of the dust extractor proximate a drill bit of the power tool (e.g., proximate the location of dust generation). Such dust extractors may also include an on-board dust container in which dust and other debris accumulates. Such dust containers are often removable from the dust extractor to facilitate disposal of the accumulated dust and debris. However, in some instanced the dust or other debris collected may clog the dust extractor or the dust container may fill before the drilling operation is complete. A clogged or full dust box prevents dust and other debris from being efficiently collected. The present disclosure provides a dust extractor configured to alerting a user to a clog or a full dust box. Alternatively, or additionally, the present disclosure provides a dust extractor capable of adjusting the operation of one or both the dust extractor or the power tool to maintain dust collection efficiency, or to balance dust collection efficiency with battery life.

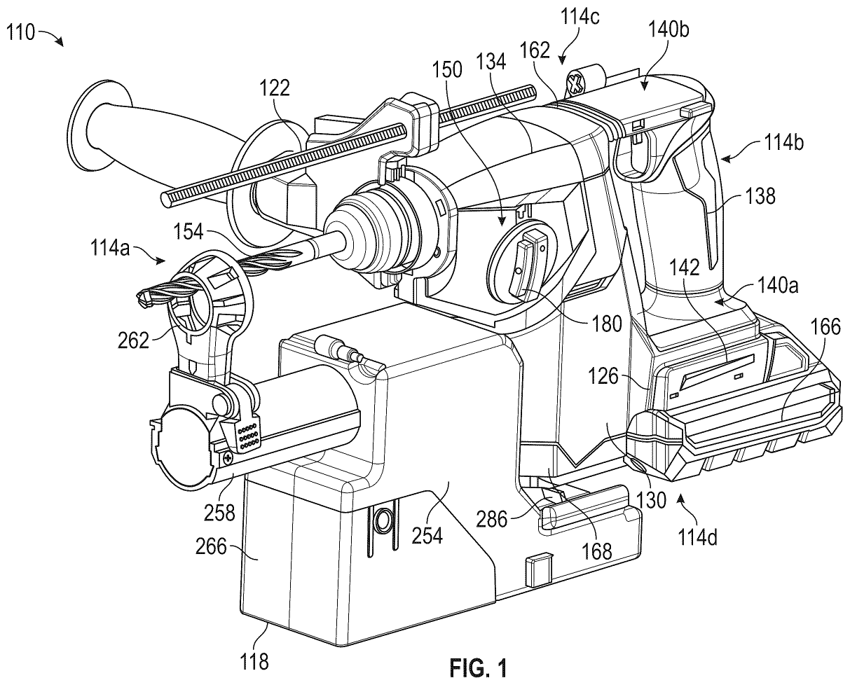

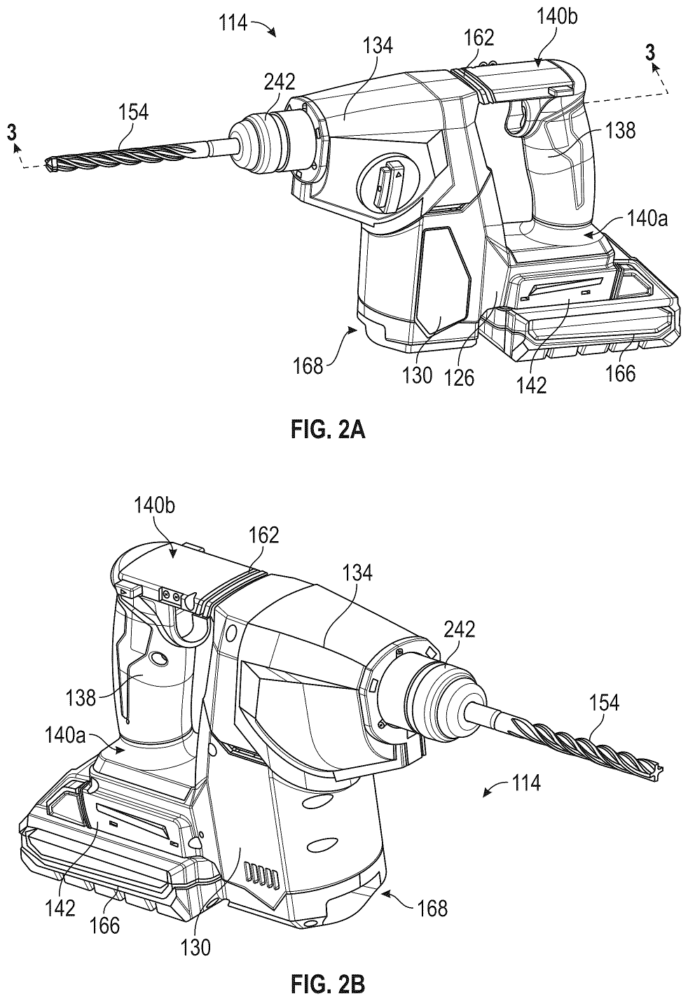

Examples of the disclosed technology can be implemented on any variety of power tools that create particulate (e.g., dust) during operation. In particular, some examples may be used with impact drivers, including rotary hammers, chisel hammers, or other known implementations. In this regard, for example, FIGS. 1, 2A, and 2B illustrate a power tool 114 in the form of a drilling machine or rotary hammer (e.g., a rotary hammer drill, a hand-held drilling tool, a percussion rotary power tool, etc.); however, the concepts described herein can also be applied to other types of power tools. For instance, in other embodiments, the power tool 114 may be another type of tool that, when in use, performs work in a way that generates dust and/or debris.

FIG. 1 illustrates a power tool assembly 110 including the power tool 114 and a dust extractor 118 that is removably coupled to the power tool 114. As will be described in greater detail herein, the dust extractor 118 is operable to collect dust and other debris generated by a drilling and/or hammering operation performed on a workpiece by the power tool 114. The dust extractor 118 prevents the dust and other debris from collecting on or in the vicinity of the workpiece. If the dust and other debris were not collected, it may decrease the effectiveness of the power tool 114 or cause a hazard to an operator of the power tool 114. In some embodiments, a secondary handle 122 may be couplable to the power tool 114 to provide an additional means for an operator to hold and control the power tool assembly 110 as will be understood by one of ordinary skill in the art. However, in other embodiments a secondary handle 122 is not included.

With reference to FIGS. 1-3, the power tool 114 includes a housing 126 (e.g., power tool housing) having a drive unit housing 130 (e.g., drive unit housing portion), a transmission housing 134 (e.g., transmission housing portion), a handle 138 (e.g., handle housing or portion), and a battery receptacle 142 (e.g., battery receptacle portion). In some cases, the housing 126 includes different pieces that support various parts of the power tool 114. For example, the housing 126 can include a pair of clamshell halves that provide an outer cover for the power tool 114. In some cases, the drive unit housing 130 or the transmission housing 134 can be configured as a gear case that houses one or more of a transmission, a reciprocation drive assembly, or an impact mechanism.

Continuing, the drive unit housing 130 houses a drive unit 146 that produces or generates torque. The transmission housing 134 houses a transmission assembly 150, which receives torque from the drive unit 146 and transmits torque to a working tool bit 154 (e.g., drill bit) to rotationally drive the tool bit 154. The transmission assembly 150 also transmits torque to an impact mechanism 158 to axially drive the tool bit 154 (e.g., reciprocate the tool bit 154 along a longitudinal axis of the tool bit 154).

The handle 138 is graspable by an operator of the power tool 114 to provide control over the power tool 114. In the illustrated embodiment, the handle 138 is coupled to the transmission housing 134 via an elastic member 162 at a top handle portion 140b. The elastic member 162 absorbs and/or dampens vibration between the transmission housing 134 and the handle 138. In some embodiments, the handle 138 is directly coupled to the transmission housing 134. In other embodiments, the clastic member 162 forms part of the handle 138, and the handle 138 is directly coupled to the transmission housing 134. That is, the elastic member 162 can be integrally formed with the handle 138 and, thus, the handle 138 is directly coupled to the transmission housing 134.

The battery receptacle 142 is disposed on the handle 138, opposite the elastic member 162. In the illustrated embodiment, the battery receptacle 142 is integrally formed with the drive unit housing 130 and with a top handle portion 140a (e.g., a bottom of the handle 138) of the handle 138. The battery receptacle 142 is configured to removably receive a battery pack 166. The battery pack 166 provides electrical power to the drive unit 146 to produce or generate torque.

The housing 126 further includes a dust extractor connection 168 (e.g., dust extractor connection portion or dust extractor connector) configured to removably receive the dust extractor 118 as will be described in greater detail herein. In some embodiments, the dust extractor connection 168 is integrally formed with the housing 126 via the drive unit housing 130. In other embodiments, the dust extractor connection 168 is removably coupled to the housing 126.

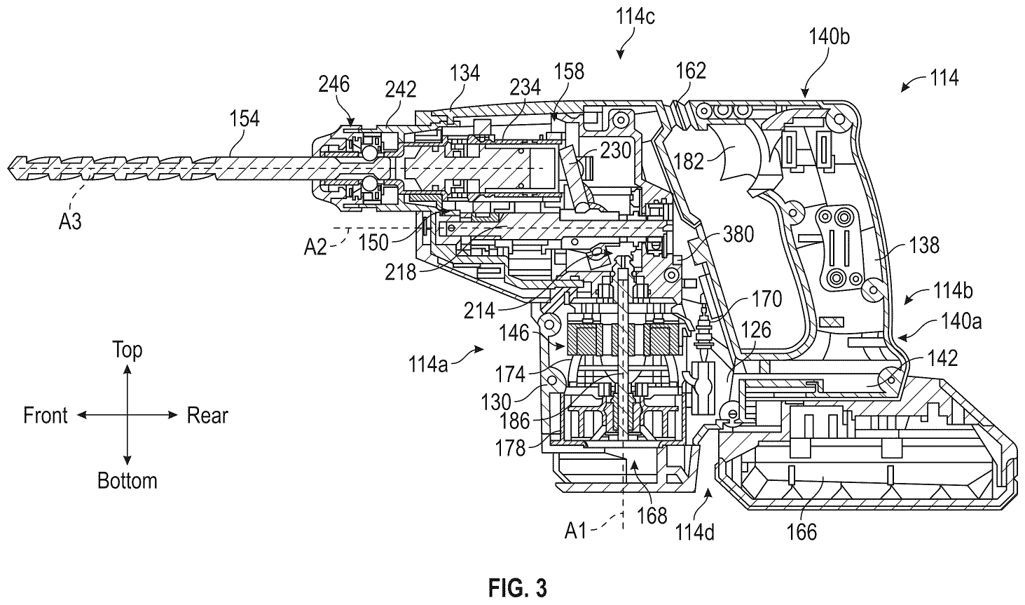

Referring to the orientation of the power tool 114 in FIG. 3, the power tool 114 has a front end 114a (e.g., a first or forward end) proximate the tool bit 154, a rear end 114b (e.g., a second or rearward end) that is opposite the front end 114a, a top end 114c (e.g., a third or topmost end) opposite the battery receptacle 142, and a bottom end 114d (e.g., fourth or bottom-most end) that is opposite the top end 114c. In the illustrated embodiment, the drive unit housing 130 is disposed at a forward and bottom-most section of the power tool 114. The transmission housing 134 is positioned above the drive unit housing 130 at a forward and upper-most section of the power tool 114. The handle 138 is positioned behind the transmission housing 134 at the rear end 114b and top end 114c of the power tool 114. The battery receptacle 142 is positioned below the handle 138 at a rear end 114b and bottom end 114d of the power tool 114. For the purposes of the present disclosure, any references made to directional locations such as forward, rearward, top, and bottom is made with respect to the directional signifier indicated in FIG. 3. It should be understood that in other embodiments, the relative locations of the portions of the power tool 114 may be different.

With continued reference to FIG. 3, the drive unit 146 includes a controller 170, such as a printed circuit board assembly (PCBA), a motor 174, and a fan 178. The controller 170 is positioned within the drive unit housing portion 130 adjacent to the battery receptacle 142, receives power from the battery pack 166, and controls operation of the motor 174.

In the illustrated example embodiment, a motor 174 (e.g., power tool motor), housed within the drive unit housing 130, can be configured as a direct-current (e.g., a brushless direct current, “BLDC”) motor that receives power from an on-board power source (e.g., a battery pack 166). The battery pack 166 may include any of a number of different nominal voltages (e.g., 12V, 18V, etc.), and may be configured having a Lithium-based chemistry (e.g., Lithium, Lithium-ion, etc.) or any other suitable chemistry. Alternatively, the motor 174 may be powered by a remote power source (e.g., a household electrical outlet) through a power cord or the motor 174 can be a different type of motor, such as an alternating-current (AC) motor. In the current example, the motor 174 is a brushless direct current (“BLDC”).

The motor 174 includes an output shaft 186 that is rotatable about a drive axis A1. A fan 178 is mounted to the output shaft 186 and is rotatable therewith to generate an airflow. The airflow is directed over the motor 174 and the controller 170 to cool the motor 174 and the controller 170, among other things.

Referring still to FIG. 3, the transmission assembly 150 includes a bevel gear train 214 and an intermediate shaft 218 that defines a transmission axis A2 extending in a front-to-rear direction. The transmission axis A2 is perpendicular to a drive axis A1. The bevel gear train 214 is coupled to the output shaft 186 to receive torque therefrom and converts rotation about the drive axis A1 to rotation about the transmission axis A2. It should be understood that in other embodiments, the gear train 214 may not be a bevel gear train depending on the form factor and the shape of the housing 126. The intermediate shaft 218 is coupled to the bevel gear train 214 to receive torque therefrom and is rotatable about the transmission axis A2.

The impact mechanism 158 includes a hammer 230 and an anvil 234 that define an impact axis A3 extending in a front-to-rear direction. The impact axis A3 is perpendicular to the drive axis A1 and is parallel to the transmission axis A2. The hammer 230 is coupled to the intermediate shaft 218 of the transmission assembly 150 such that rotation of the intermediate shaft 218 drives the hammer 230 to strike the anvil 234 at periodic intervals.

With continued reference to FIG. 3, the power tool 114 further includes an output chuck 242 that extends through the transmission housing 134 at the front end 114a of the power tool 114. The output chuck 242 is adapted to receive the tool bit 154. In the illustrated embodiment, the output chuck 242 includes a detent mechanism 246 to retain the tool bit 154. The output chuck 242 is positioned such that the tool bit 154 is aligned with the impact axis A3, such that the impact axis A3 also defines a rotational axis of the tool bit 154 and an axis of reciprocation of the tool bit 154.

During operation of the power tool 114, the controller 170 provides power from the battery pack 166 to the drive unit 146 upon actuation of the trigger 182 by an operator. The drive unit 146 generates torque, and the transmission assembly 150 transmits the torque to the impact mechanism 158 to drive the tool bit 154.

FIGS. 1 and 4-6 illustrate the dust extractor 118. The dust extractor 118 includes a dust extractor housing 254 (e.g., dust collector housing), a suction tube 258 (e.g., an extension tube), a suction head 262 coupled to the suction tube 258, a dust box 266, a dust box connection tube 270 (e.g., dust tube), a filter 274, a filter cleaning mechanism 278, a suction generator 282, and a tool connection mechanism 286. The dust extractor 118 is removably couplable to the power tool 114, via the tool connection mechanism 286, such that the suction head 262 is disposed adjacent to the tool bit 154 (e.g., toward the bottom end 114d of the power tool 114 relative to the tool bit 154), the dust extractor housing 254 is supported by the power tool housing 126, and the dust extractor 118 receives power from the battery pack 166 (FIG. 1).

Continuing, the suction tube 258 includes a first suction tube 260a and a second suction tube 260b. The second suction tube 260b extends from the first suction tube 260a, and the first suction tube 260a extends from the dust extractor 118. Further, the suction tube 258 is a telescoping suction tube that is adjustable between an extended position and a retracted position. In the extended position, the first suction tube 260a and/or the second suction tube 260b extend out from the dust extractor 118. The suction head 262 may be adjustable to move between the extended configuration and the retracted configuration to accommodate a distance between the dust extractor 118 and a drilling surface of the tool bit 154. For instance, at the beginning of operation, the suction head 262 may be further extended from the dust extractor 118 (and the power tool 114) than at the end of operation after drilling has been completed. In the retracted position, the suction head 262 of the suction tube 258 is positioned at its closest position to the power tool 114 (e.g., the suction head is as proximate to the power tool 114 as possible). In some embodiments, the retracted position may be the rest, storage, or non-use position of the dust extractor 118.

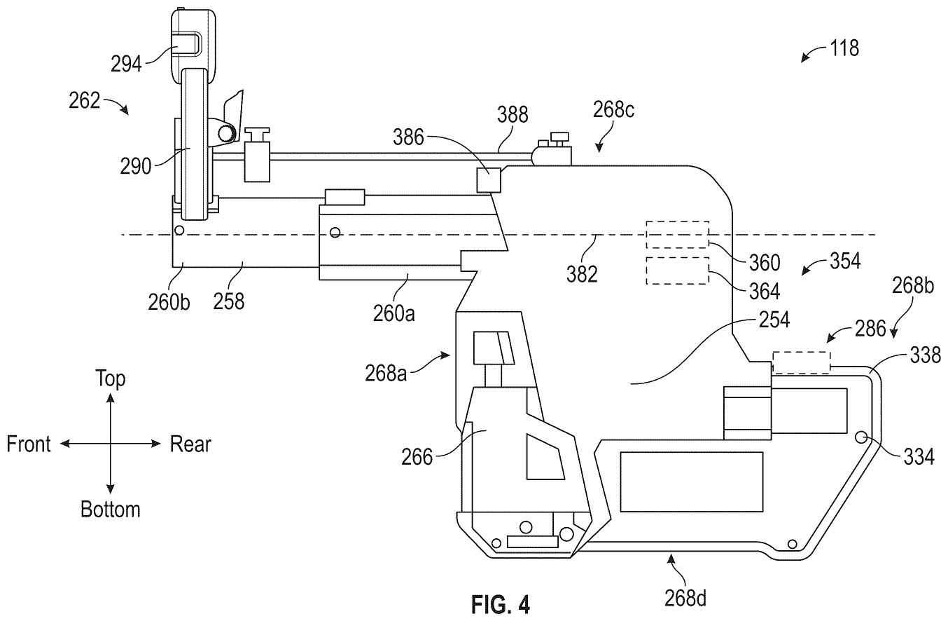

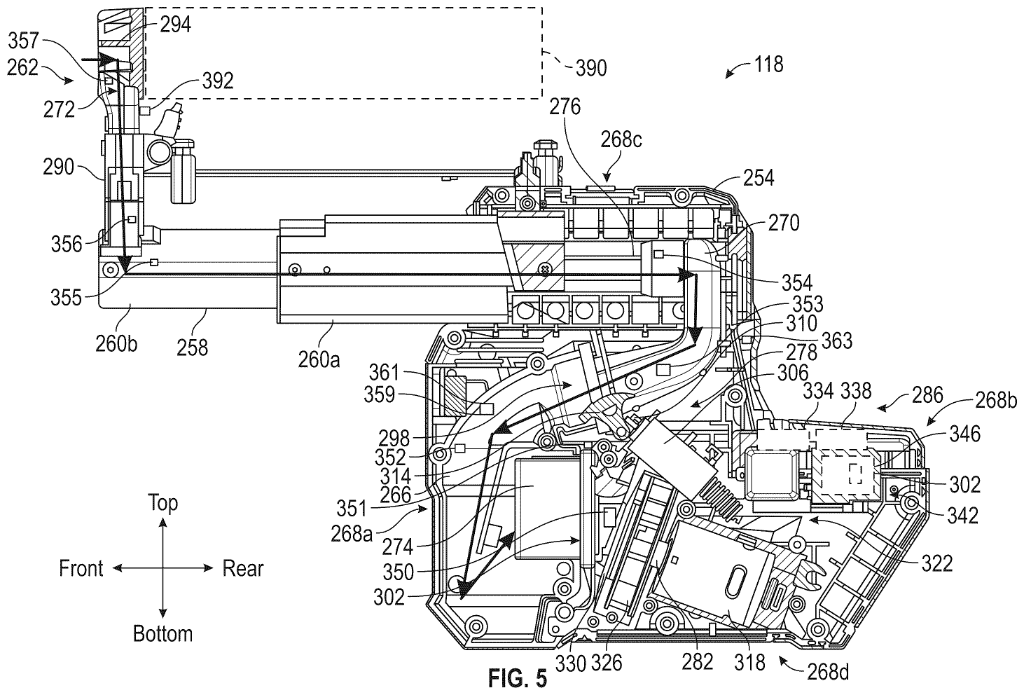

With reference to FIGS. 4 and 5, the suction head 262 extends from the suction tube 258 (e.g., the second suction tube 260b) at an end opposite the dust extractor housing 254 and is positioned such that, when the dust extractor 118 is coupled to the power tool 114, the tool bit 154 extends through a portion of the suction head 262, as shown in FIG. 1. In particular, the suction head 262 includes a head tube 290 in fluid communication with the suction tube 258 and a collection shroud 294 in fluid communication with the head tube 290. The head tube 290 extends perpendicularly to the suction tube 258, and the collection shroud 294 extends from the head tube 290 opposite the suction tube 258. The collection shroud 294 includes an opening through which the tool bit 154 extends and an entrance through which airflow containing dust and other debris is directed into the dust extractor 118.

Referring to the orientation of the dust extractor housing 254 in FIGS. 4 and 5, the dust extractor housing 254 (or dust extractor 118) has a front end 268a 114a (e.g., a first or forward end) proximate the suction tube 258, a rear end 268b (e.g., a second or rearward end) that is opposite the front end 268a, a top end 268c (e.g., third or topmost end) that when the dust extractor 118 is coupled to the power tool 114, the top end 268c is positioned below the tool bit 154, and a bottom end 268d (e.g., fourth or bottom-most end) that is opposite the top end 268c.

With reference to FIG. 5, the dust box connection tube 270 is disposed within the dust extractor housing 254 and is in fluid communication with both the suction tube 258 and the dust box 266. In the illustrated embodiment, the dust box connection tube 270 defines a non-linear pathway (e.g., a pathway 272) between the suction tube 258 and the dust box 266. An entrance 276 of the dust box connection tube 270 is disposed proximate a top end 268c and a rear end 268b of the dust extractor 118 and in fluid communication with the suction tube 258. The dust box connection tube 270 then turns downward and forward, passing through a dirty air inlet 298 and toward the front end 268a and the bottom end 268d of the dust extractor 118, in the perspective of FIG. 5, toward the dust box 266. The dust box connection tube 270 transfers dust and other debris that has been collected by the suction head 262 to the dust box 266.

With reference to FIGS. 4 and 5, the dust box 266 is releasably connected to the dust extractor housing 254 and adapted to contain dust and other debris that has been collected. The dust box 266 defines a dust storing space in which dust and other debris generated during a drilling and/or hammering operation of the power tool is collected. The dust box 266 includes the dirty air inlet 298 (e.g., an inlet), which is in fluid communication with the dust box connection tube 270 when the dust box 266 is coupled to the dust extractor housing 254. The dust box 266 further includes a clean air outlet 302 (e.g., an outlet) in fluid communication with the suction generator 282. In the illustrated embodiment, the dust box 266 is removable from the dust extractor housing 254 such that an operator may empty dust and other debris that has been collected. In other embodiments, the dust box 266 may be non-removable and may instead have an opening or door that allows for removal of the dust and other debris.

The filter 274 is disposed within the dust extractor housing 254 and positioned between the dirty air inlet 298 and the clean air outlet 302. Here the filter 274 is positioned such that, when the dust box 266 is coupled to the dust extractor housing 254, at least a portion of the filter 274 extends through the clean air outlet 302 of the dust box 266. The filter 274 seals the clean air outlet 302 to prevent the dust and other debris from exiting the dust box 266, while allowing air to flow out of the dust box 266. In some embodiments, the filter 274 may be a HEPA filter.

The filter cleaning mechanism 278 is disposed within the dust extractor housing 254 adjacent to the filter 274. The filter cleaning mechanism 278 is operable to generate impacts on or near the filter 274 to remove debris from the filter 274. For example, the filter cleaning mechanism 278 may impact the filter 274 upon completion of a drilling or hammering operation to knock dust off the filter 274 and into the dust box 266. Thus, the filter cleaning mechanism 278 aids in minimizing clogging of the filter 274. In the illustrated embodiment, the filter cleaning mechanism 278 includes a solenoid 306 (e.g., an actuator) having a plunger 310 that is biased towards a retracted position. A striker 314 is disposed adjacent to the solenoid 306 and adapted to impact the filter 274. The striker 314 of the illustrated embodiment is rotatably (e.g., pivotably) supported by the dust extractor housing 254 adjacent to the solenoid 306. When the solenoid 306 is actuated or energized, the plunger 310 drives the striker 314 to rotate the striker 314 towards the filter 274, thereby causing the striker 314 to impact the filter 274.

The suction generator 282 includes a motor 318 (e.g., a dust extractor motor), a controller 322 (such as a PCB or PCBA) operatively coupled to the motor 318, and a suction fan 326 (e.g., a dust fan, a fan, etc.) rotatably coupled to the motor 318 and operable to generate an airflow through the dust extractor 118. The suction generator 282 is disposed within the dust extractor housing 254 on an opposite side of the filter 274 as the dust box 266 (e.g., a clean air side). In other words, the filter 274 divides the dust extractor 118 into a dirty side, which includes the dust box 266 and the components upstream of the dust box 266, and a clean side, downstream of the filter 274. The airflow pathway 272 flows through the dirty side of the dust extractor 118, as shown by the arrows of the pathway 272 in FIG. 5. The suction generator 282 is positioned adjacent to the filter 274 in the illustrated embodiment. In particular, the suction fan 326 is disposed adjacent to the filter 274 and is coupled to the motor 318 to be rotatably driven by the motor 318. In the illustrated embodiment, a shroud 330 is disposed about the suction fan 326 and operable to direct airflow generated by the suction fan 326. As the motor 318 rotates the suction fan 326, the suction fan 326 generates a negative pressure between the suction fan 326 and the filter 274 such that air flows through the suction head 262, the suction tube 258, the dust box connection tube 270, and into the dust box 266 as illustrated by pathway 272 in FIG. 5. From the dust box 266, the air flows through the filter 274 and into the clean air side of the dust extractor housing 254 to be exhausted. The filter 274 prevents dust and other debris entrained within the air as it enters the dust extractor 118 from exiting the dust box 266. In some embodiments, the air, after entering the clean side of the dust extractor housing 254, may be directed over the motor 318 and the controller 322 to cool the motor 318 and the controller 322.

In some embodiments, some, or all, of the components of the suction generator 282 may be implemented in the power tool 114, rather than the dust extractor 118 (e.g., as aa power tool having an integrated dust extractor). For example, the controller 170 of the power tool 114 may be operatively coupled to the motor 318 of the suction generator 282 when the dust extractor 118 is coupled to the power tool 114. In such an embodiment, the dust extractor 118 does not require the controller 322. Furthermore, in some embodiments, the dust extractor 118 does not include a suction generator 282 and, instead, relies upon components of the power tool 114 to generate the suction airflow. In such an embodiment, the dust extractor 118 may be in fluid communication with the power tool 114 when coupled to the power tool 114 such that airflow generated by the motor 174 operating the fan 178 of the power tool 114 flows through the dust extractor 118 to draw the dust and other debris into the dust extractor 118.

The tool connection mechanism 286 of the dust extractor 118 operatively couples the dust extractor 118 to the power tool 114. The tool connection mechanism 286 includes a first connection 334 (e.g., a mechanical or other type of connection) to physically couple the dust extractor housing 254 to the housing 126 of the power tool 114 and a second connection 338 (e.g., an electrical connection, communication link, etc.) to operatively couple the controller 322 of the dust extractor 118 to the controller 170 of the power tool 114. In the illustrated embodiment, the electrical connection 338 provides a means of electrical connection between the power tool 114 and the dust extractor 118 such that the battery pack 166, which is coupled to the power tool 114, may provide power to the motor 318 of the dust extractor 118. In some embodiments, the electrical connection 338 may directly couple the motor 318 to the controller 170 of the power tool 114 instead of including a controller 322 in the dust extractor 118.

During a working operation, the collection shroud 294 may be pressed against a workpiece such that the tool bit 154 extends through the collection shroud 294 and into the workpiece. The suction generator 282 creates an airflow through the dust extractor 118 such that dust and other debris generated by the tool bit 154 is drawn into the collection shroud 294. The air, including the dust and other debris, is then directed through the head tube 290 and into the suction tube 258. From the suction tube 258, the air flows into the dust box connection tube 270 and the dust box 266. The air is then drawn through the filter 274 to exit the dust box 266, while the filter 274 prevents the dust and other debris from leaving the dust box 266.

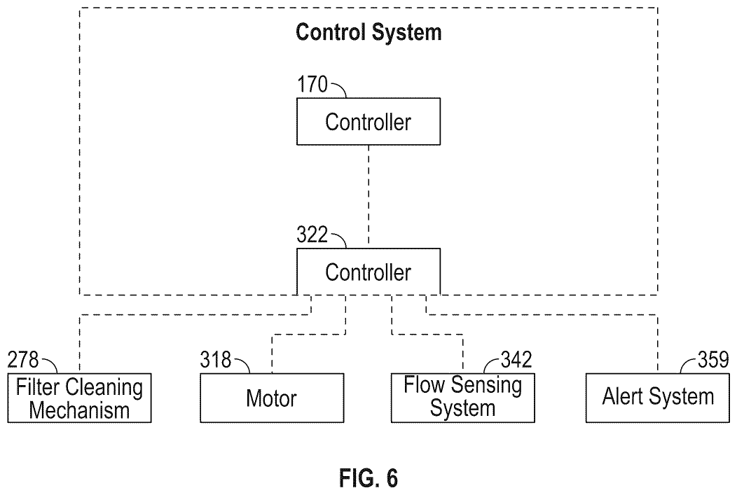

The dust extractor 118 of the illustrated embodiment further includes a flow sensing system 342 operable to detect an airflow characteristic (e.g., pressure, mass airflow, airflow velocity, etc.) of the airflow through the dust extractor 118 during operation, as shown in FIG. 6. The flow sensing system 342 includes a set of sensors in communication with the controller 322 (e.g., or the controller 170 when the dust extractor 118 is integrated with the power tool 114). Based on signals from the flow sensing system 342, the controller 322 can detect or determine the measured characteristic and selectively operate the filter cleaning mechanism 278 to clean the filter 274 and maintain the characteristic at a desired value or within a desired range of values (e.g., threshold value).

In the illustrated example, the flow sensing system 342 includes a pressure sensor 346 operatively coupled to the controller 322. In other embodiments, the flow sensing system 342 may include other types of sensors to detect other characteristics of the airflow. In the illustrated embodiment, the pressure sensor 346 is a differential pressure sensor that is in fluid communication with the clean air side of the dust extractor 118 and with the atmosphere. A pressure port 350 is disposed between the suction fan 326 and the filter 274 (e.g., within the shroud 330), and the pressure sensor 346 is coupled to the pressure port 350 to detect the pressure of air between the suction fan 326 and the filter 274. Such arrangements allow for pressure sensors to be positioned remotely from the location where pressure is being sensed, as may reduce potential for contamination of the sensors. In some embodiments, the pressure sensor 346 may be coupled to the pressure port 350 via a tube such that the pressure sensor 346 may be positioned remote from the pressure port 350 adjacent to the controller 322. In other embodiments, the pressure sensor 346 may be directly coupled to the pressure port 350. The location of the pressure port 350 within the clean air side of the dust extractor 118 prevents dust and other debris from interfering with the pressure sensor 346. In other examples, pressure sensors can be positioned at the pressure ports, as may reduce the need for the ports.

As the dust extractor 118 operates to collect dust and other debris, the suction fan 326 generates negative pressure on the clean side of the filter 274 adjacent to the pressure port 350. That is, the suction fan 326 reduces pressure on the clean side (e.g., downstream side) of the filter 274 to be less than the pressure on the dirty side (e.g., the upstream side) of the filter 274. If the dust box 266 is full, air is restricted from flowing through the dust box 266, and a magnitude of the negative pressure in the area between the suction fan 326 and the filter 274 increases. Similarly, if the filter 274 is clogged, air is restricted from passing through the filter 274 and the magnitude of the negative pressure in the area between the suction fan 326 and the filter 274 increases. The pressure sensor 346 detects the magnitude of the pressure at the pressure port 350 and of the atmosphere. Based on signals from the pressure sensor 346 indicative of the magnitude of the pressure, the controller 322 can monitor (e.g., detect an increase in) the magnitude of the negative pressure at the pressure port 350. When the magnitude of the negative pressure exceeds a predetermined threshold, the controller 322 determines that the dust box 266 is full or the flow path is clogged.

It some cases, it can be advantageous to include a plurality of pressure sensors, as may allow for calculating various pressure differentials along the air flow path. Such arrangements can allow a controller to determine a location of reduced airflow or a type of obstruction or other cause of reduced airflow, which can be communicated to a user or used to control operations of the power tool, as described further below. It can therefore be advantageous to provide pressure sensors or ports for pressure sensors at or around regions where obstructions are likely to occur, for example, at regions with reduce cross-sectional area, curves, or bends, or where dust collects (e.g., the dust box). For example, a second pressure port 352 can be positioned within the dust box 266, upstream of the filter 274. The second pressure port 352 can be positioned between the filter 274 and the junction between the dust box connection tube 270 and the dust box 266A third pressure port 353 can be positioned at an outlet of the dust box connection tube 270, proximate the connection with the dust box 266, the junction between the dust box connection tube 270 and the dust box 266. The third pressure port 353 can be in the dust box connection tube 270 or in the dust box 266 (e.g., at an inlet of the dust box 266). A fourth pressure port 354 can be positioned proximate an inlet of the dust box connection tube 270, near the junction between the suction tube 258 and the dust box connection tube 270. The fourth pressure port 354 can be in the dust box connection tube 270 or in the suction tube 258 (e.g., at an outlet of the suction tube 258). A fifth pressure port 355 can be positioned proximate an inlet of the suction tube 258, near the junction between the suction tube 258 and the head tube 290. The fifth pressure port 355 can be in the suction tube 258 or in the head tube 290 (e.g., at an outlet of the head tube 290). A sixth pressure port 356 can be positioned in the head tube 290, near the junction between the head tube 290 and the suction tube 258. A seventh pressure port 357 can be positioned in the collection shroud 294. The pressure port 350-357 can be in communication with pressure corresponding pressure sensors positioned remotely from the ports, as discussed above in connection with pressure sensor 346. Correspondingly, in other examples, pressure sensors can be positioned along the flow path at the positioned of the ports. That is, the ports can be replaced with pressure sensors, which can be positioned as described above.

In an embodiment including a plurality of pressure ports 350, the controller 322 may monitor the magnitude of the negative pressure at each pressure port 350 utilizing a plurality or pressure sensors 346 to determine if a clog exists at one or more locations along the air flow path. For example, a pressure differential between the first port 350 and the second port 352 (or any other port upstream of the first pressure port 350) can indicated if the filter 274 is clogged and needs to be cleaned, or that the dust box 266 is full. A pressure differential between the second port 352 and the third port 353 (or any other port upstream of the second port 352) can indicate a clog or other obstruction at the junction of the dust box 266 and dust box connection tube 270. A pressure differential between the third port 353 and the fourth port 354 (or any other port upstream of the third port 353) can indicate a clog or other obstruction along the dust box connection tube 270. A pressure differential between the fourth port 354 and the fifth port 355 (or any other port upstream of the fourth port 354) can indicate a clog or other obstruction along the suction tube 258, for example, at a junction of the dust box connection tube 270 and the suction tube 258. A pressure differential between the fifth port 355 and the sixth port 356 (or any other port upstream of the fifth port 355) can indicate a clog or other obstruction along the head tube 290, for example, at a junction of the suction tube 258 and the head tube 290. A pressure differential between the sixth port 356 and the seventh port 357 (or any other port upstream of the sixth port 356) can indicate a clog or other obstruction along the head tube 290 or the collection shroud 294, for example, at a junction of the head tube 290 and the collection shroud 294 . . . . Thus, when the dust extractor 118 includes a plurality of pressure ports or pressure sensors, the controller 322 may distinguish between a clog, as well as an approximated position of the clog, and a dust box 266 that is full.

In some cases, other types of sensors can be used to determine the source of an obstruction (e.g., a cause of restricted airflow). For example, a fill sensor 359 can be positioned in the dust box 266 to monitor a level of dust or other debris collected therein. The fill sensor 359 can be, for example, a light sensor that can detect an amount of light within the dust box 266. The light can be from an external source (e.g., from light passing through the walls of the dust box 266), or an internal source 351 (e.g., an LED or other lighting element). When the detected light drops below a predetermined value, the fill sensor 359 can provide a signal indicating the fill level. In some case the fill sensor 359 can be used in conjunction with pressure sensors to determine whether reduced air flow is due to a clogged filter 274 or a full dust box 266. The fill sensor 359 can be in communication with the controller 322, as discussed below, to allow the controller 322 to alert the user of a reduced flow condition, or to control other operations of the tool 100 based on sensing restricted flow.

In other examples, the fill sensor 359 can be another type of sensor, such as a particle sensor 363. The particle sensor can sense a concentration of particles (e.g., silica particles, cellulose particles, etc.) in the air around the tool, or in another part of the airstream (e.g., filter exhaust). If particle concentration reaches a threshold value, this may indicate that the dust extractor 118 is not adequately removing particles from the airstream, as may be consistent with reduced airflow through the dust extractor 118. In response to detecting a particle level at or above the threshold, the fill sensor 359 can send a signal (e.g., to the controller 322) to alert the user of the increased particulate condition and that maintenance on the dust extractor 118 may be required, or to control other operations of the tool 100. In still other examples, other types of fill sensors can be used, such as mechanical switch (e.g., a float-operated switch), mass sensors, timers, etc.

The dust extractor 118 further includes an alert system 359 operatively coupled to the controller 322 to notify an operator when the flow sensing system 342 detects a dust box 266 that is full or a clog. The alert system 359 may be a visual alert, in the form of a light 360 (e.g., an LED or indication on a screen), and/or may be an audio alert, in the form of a speaker 364. In the illustrated embodiment, the light 360 is an LED disposed on the dust extractor housing 254. The light 360 may be illuminated in a first color (e.g., green) during normal operation of the dust extractor 118 and may be illuminated in a second color, different from the first color, (e.g., red) when the flow sensing system 342 determines that the dust box 266 is full or a clog exists. In some embodiments, the light 360 of the dust extractor 118 may be a plurality of color changing LEDs corresponding in number and position to the plurality of pressure ports 350. In such an embodiment, the controller 322 may control the plurality of color changing LEDs individually to indicate to an operator the location of a clog. In some embodiments, the alert system 359 may be disposed on the housing 126 of the power tool 114, rather than on the dust extractor housing 254.

The flow sensing system 342 provides the controller 322 with information regarding the airflow through the dust extractor 118 and may be utilized to control other operations of the power tool 114 other than a dust box 266 that is clogged or full to an operator. For example, when the controller 322 detects that the dust box is a clogged or full dust box, the controller 322 may automatically turn off the dust extractor 118 (e.g., the suction generator 282) to prevent damage to the suction generator 282. The controller 322 may further automatically actuate the filter cleaning mechanism 278 upon detecting that the dust box 266 is clogged and/or full. In some embodiments, the electrical connection 338 between the dust extractor 118 and the power tool 114 allows the controller 322 to notify the controller 170 of the power tool 114 to turn off the power tool 114 in the event that the dust box 266 is clogged or full. Furthermore, the controller 322 may utilize data from the flow sensing system 342 to implement a control scheme for the suction generator 282 based on the airflow through the dust extractor 118. Rather than running the suction generator 282 at a set power, the controller 322 may optimize the power supplied to the motor 318 to increase or decrease the airflow rate based on the data provided by the flow sensing system 342. Such a control scheme may increase the efficiency of the dust extractor 118.

In some cases, a controller can monitor other parameters of a tool and control airflow (e.g., motor speed or power) based on the sensed operating parameter. For example, the power tool 114 or the dust extractor 118 can include an orientation sensor 380 (see e.g., FIG. 3). The orientation sensor 380 is configured to determine how the power tool 114 or the dust extractor 118 is positioned in space, relative to a direction of gravity, and can be in communication with the controller 322. The controller 322 can modulate the speed or power of the motor 318 based on the sensed orientation to optimize suction performance with battery life. For example, at a neutral position corresponding to having an extension axis 382 (see FIG. 4) of the suction tube 258 perpendicular to a direction of gravity, the controller 322 can operate the motor 318 at a first speed or power (e.g., a normal power). However, in a downward position corresponding to having the extension axis 382 of the suction tube 258 angled down relative to gravity so that the suction shroud 294 is below the dust box 266 or the dust box connection tube 270, the controller 322 can operate the motor 318 at a second speed or power (e.g., a high power) that is greater than the first speed or power. This allows for increased airflow to move the dust or debris along the suction tube 258 against the force of gravity to the dust box 266. Conversely, in an upward position corresponding to having the extension axis 382 of the suction tube 258 angled up relative to gravity so that the suction shroud 294 is above the dust box 266 or the dust box connection tube 270, the controller 322 can operate the motor 318 at a third speed or power (e.g., a low power) that is less than the first speed or power. This allows battery power to be conserved while maintaining suction performance, as the dust or debris is aided to move along the suction tube 258 to the dust box 266 by the force of gravity. It is appreciated that controller 322 can operate the motor 318 over a continuously variable range of powers or speeds, or at a plurality of discrete speed or power levels, based on the detected orientation.

In some case, a controller can operate a motor in accordance with a length of a suction tube. For example, as the suction tube 258 is extended and retracted to change the length along the extension axis 382, the airflow resistance may change accordingly. In particular, a longer suction tube 258 generally has higher flow resistance, and therefore loses, than does a shorter suction tube 258. Accordingly, the controller 322 can operate the motor 318 at a first speed or power at a first axial length of the suction tube 258, and operate the motor 318 at a second speed or power at a second axial length of the suction tube 258 that is less than the first axial length. The first speed or power can be greater than the second speed or power. To determine the length of the suction tube 258, the controller 322 can be in communication with a distance sensor 386. The distance sensor 386 can be a hall-effect sensor, a potentiometer, a mechanical switch, or another type of sensor that sends a signal to the controller 322 corresponding to position of the suction tube 258. For example, the distance sensor can send a first signal at a first position of the suction tube 258 corresponding to the first axial length and a second signal at second position of the suction tube 258 corresponding to the second axial length. As shown in FIG. 4, the distance sensor 386 can be positioned (e.g., on the dust extractor housing 254 or the housing 126) to sense a movable portion of the dust extractor 118. For example, the distance sensor 386 can detect the suction tube 258, or a rule 388 (e.g., a depth stop) of the dust extractor 118. In other case, the distance sensor 386 can be positioned differently, for example, on the suction tube 258 or the rule 388.

In some examples, a dust cover can be position over a bit, as may improve dust collection in some operating conditions, such as overhead drilling. For example, as shown in FIG. 5, a dust cover 390 can optionally be supported on the collection shroud 294 to improve dust containment. The dust cover 390 can be coupled between the collection shroud 294 and the housing 126 of the power tool 114 so that the dust cover 390 extends over and surrounds the tool bit 154 and the output chuck 242. The dust cover 390 can collapse and extend between the collection shroud 294 and the housing 126 in accordance with extension and retraction of the suction tube 258. When the dust cover 390 is attached resistance to airflow can be increased, as compared with when the dust cover is not used. Accordingly, a sensor 392 can be used to detect whether the dust cover 390 is attached. Here, the sensor 392 is positioned on the collection shroud 294, however, the sensor 392 may be positioned differently in other examples, such as on the dust cover 390 or the housing 126. The sensor 392 can be in communication with the controller 322 and can send a signal to the controller 322 to indicate whether the dust cover 390 is attached or detached. In accordance with the signal from the sensor 392, the controller 322 can modulate the speed or power of the motor 318. For example, the controller 322 can operate the motor 318 at a first speed or power when the dust cover 390 is attached and at a second speed or power when the dust cover is detached. The first speed or power can be greater than the second speed or power. Additionally, the controller 322 can modulate speed or power of the motor 318 as the dust cover 390 collapses and extends. For example, the controller 322 can increase or decrease speed or power of the motor 318 as the dust cover 390 collapses, or vice versa.

In some cases, the controller 322 can control the speed or power of the motor 318 in accordance with feedback from multiple sensors, as generally discussed above. For example, the controller 322 can change motor speed or power based on whether the dust cover 390 is attached and also modulate the motor 318 speed or power based on the orientation of the power tool 114, extension or retraction of the suction tube 258 or dust cover 390, or in accordance with restricted airflow due to obstruction in the dust extractor 118. Thus, it is appreciated that the controller 322 can modulate motor 318 speed or power in accordance with any combination of the operating parameters discuss above, or other operating parameters. Correspondingly, any actions taken by the controller 322 can alternatively be performed by the controller 170, as may occur with an integrated dust extractor. Additionally, the motor 174 may also be controlled by the controller 322 or the controller 170 based on input from the various sensors.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, one having ordinary skill in the art will appreciate that specific features of the numerous embodiments disclosed may be mixed and matched in other ways where not specifically inhibited, even though specific illustration of such embodiments may not be exhaustively covered herein. In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

Various features of the invention are set forth in the following claims.

What is claimed is:

1. A power tool comprising:
a first housing;
a dust box coupled to the first housing and defining an inlet and an outlet;
a filter positioned between the inlet and the outlet;
a first motor operating a fan to generate an airflow across the filter between the inlet and the outlet;
a first sensor to sense an airflow characteristic of the airflow;
a second sensor to sense an operating parameter of the power tool; and
a first controller in communication with the first sensor to monitor the airflow characteristic of the airflow and the second sensor to monitor the operating parameter, the first controller controlling operation of the power tool based on a value of the airflow characteristic and the operating parameter.

2. The power tool of claim 1, wherein the operating parameter is at least one of:
a length of a suction tube that extends and retracts relative to the dust box,
a fill level of the dust box, and
a dust cover being attached to the power tool.

3. The power tool of claim 1, wherein the airflow characteristic is at least one of:
an air pressure downstream of the filter, and
a first concentration of particles in the air around the tool, and
a second concentration of particles in the airflow exiting the filter.

4. The power tool of claim 1, where the first controller stops the first motor when the value of the airflow characteristic reaches the threshold value.

5. The power tool of claim 1 further comprising an alert system in communication with the controller so that the controller activates the alert system when the value of the airflow characteristic reaches the threshold value.

6. The power tool of claim 5, wherein the alert system includes an LED indicator that is activated by the controller.

7. The power tool of claim 1 further comprising a filter cleaning mechanism in communication with the controller so that the controller activates the filter cleaning mechanism when the value of the airflow characteristic reaches the threshold value.

8. The power tool of claim 7, wherein the filter cleaning mechanism includes a solenoid that is operated by a controller to provide impacts to the filter.

9. The power tool of claim 1, wherein the first housing is a dust extractor housing and further comprising a power tool housing, the dust extractor housing configured to removably couple to power tool housing.

10. The power tool of claim 9, wherein the first motor is a dust extractor motor that is positioned within the dust extractor housing and further comprising a power tool motor configured to perform a work operation of the power tool.

11. The power tool of claim 10, wherein the first controller positioned within the dust extractor housing to control operation of the dust extractor motor and further comprising a second controller positioned within the power tool housing to control operation of the power tool motor, the first controller in communication with the second controller.

12. The power tool of claim 11, wherein the second controller controls operation of at least one of the power tool motor and an alert system based on a first signal sent from the first controller when the value of the airflow characteristic reaches the threshold value.

13. The power tool of claim 11, wherein the first controller operates the first motor based on a second signal sent from the second controller to the first controller.

14. A dust extractor for use with a rotary power tool, the dust extractor comprising:
a housing;
a suction tube extending from the housing to collect dust and other debris generated by the rotary power tool;
a dust box including an inlet and an outlet, the inlet in fluid communication with the suction tube;
a suction generator configured to generate an airflow to draw the dust through the suction tube and into the dust box, and to draw the airflow through the outlet of the dust box;
a filter positioned adjacent the outlet of the dust box, the filter separating the dust from the airflow so that the dust remains within the dust box and clear air flows through the filter;
a flow sensing system including a first pressure sensor that senses a first pressure of clean air exiting the filter and a second pressure sensor that senses a second pressure of dirty air that enters the filter; and
a controller in communication with the pressure sensor, the controller configured to calculate a pressure differential between the first pressure and the second pressure and to determine when the dust box is full or when the filter is clogged based on the pressure differential.

15. The dust extractor of claim 14, wherein the controller turns off the suction generator upon determining that the dust box is full or that the filter is clogged.

16. The dust extractor of claim 15, further comprising an alert system in communication with the controller, wherein the controller activates the alert system upon determining that the dust box is full or that the filter is clogged.

17. The dust extractor of claim 16, wherein the alert system includes a color changing LED.

18. The dust extractor of claim 14, wherein each the first pressure sensor and the second pressure sensor senses pressure in corresponding pressure port.

19. The dust extractor of claim 14, further comprising a filter cleaning mechanism in communication with the controller, wherein the controller activates the filter cleaning mechanism upon determining that the dust box is full or that the filter is clogged.

20. A dust extractor for use with a rotary power tool, the dust extractor comprising:
a housing;
a suction tube extending from the housing, the suction tube configured to collect dust and other debris generated by the rotary power tool;
a dust box in fluid communication with the suction tube;
a suction generator to generate an airflow to draw the dust through the suction tube and into the dust box, and through an outlet of the dust box; and
a flow sensing system including:
a pressure port disposed between the suction generator and the dust box, and
a pressure sensor positioned outside of the dust box and in fluid communication with the pressure port,
wherein the pressure sensor is configured to detect a pressure differential between the pressure port and atmospheric pressure; and
a controller in communication with the pressure sensor, the controller configured to determine when the dust box is full or when a filter is clogged based on the pressure differential.
